(19) United States
(12) Patent Application Publication
(10) Pub. No.: US 2008/0095286 A1
(43) Pub. Date: Apr. 24, 2008

(54) Measurement System for Delay Between Two Signals Transmitted Via Two Transmission Paths

(75) Inventor: Erik Lieuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,999

(22) PCT Filed: Jul. 11, 2005
(86) PCT No.: PCT/IB05/52292

§ 371 Date: Jan. 12, 2007

(30) Foreign Application Priority Data
Jul. 15, 2004 (EP) 04103386.1

(51) Int. Cl. H04L 7/00

(52) U.S. Cl. 375/354

(57) ABSTRACT

System for determining a time delay between a first and second different transmission path, whereby the first transmission path can be the path of a video signal and the second transmission path can be the path of a corresponding audio signal, the system comprising a sender and a receiver wherein said sender comprises the following functionalities: -a transmit function to transmit over a first transmission path a predetermined first signal, and a start function to start a timer at a first moment substantially simultaneously with the transmit function; -a wait function to wait for an acknowledgement of a reception of said second signal by said receiver, said acknowledgement being sent along a return transmission path that shows substantially no delay when compared to said time delay, -a stop function to stop upon reception of said acknowledgement, said timer at a second moment, -a calculation function to calculate said time delay as being a difference between said second moment and said first moment, -a storage function to store said time delay in a delay unit to delay a transmission of a second signal via said second transmission path and said receiver comprises the following functionalities: a receive function to receive said first signal, a check function to check whether said first signal equals a reference signal stored in a memory and if so, a send function to send said acknowledgement of said reception to said sender along said return transmission path.

The invention relates to a system for determining a time delay between at least two different transmission paths, said system comprising a sender and a receiver. Also, the present invention relates to a method, a computer program product, a sender and receiver for determining a time delay between at least two different transmission paths.

Presently, a well known problem in the electronics industry is that the processing time of different signals may be different. Processing time may, depending on the context, below both refer to time needed to process a signal in a device and time needed to transmit a signal over a link. In particular in audio video devices, processing time of an audio signal is different from the processing time of a video signal. Typically the processing time of a video signal is (much) longer than the processing time of an audio signal. The longer processing time may, for instance, be caused by compression and decompression operations on the video signal. The difference in processing time between the audio signal and the video signal may cause unacceptable loss of synchronization between the two signals. This may eventually mean that a person who is watching a movie on, for instance, a television will already hear the audio although not yet seeing the picture corresponding to the audio. Such a situation has to be avoided.

A system that partly tackles this problem is, among others, known from European patent application EP 1 104 179. This publication describes a device that measures the transmission time of a signal through an audio processing unit and the transmission time of a signal through a video processing unit. On the basis of the difference in the transmission times of the audio and video signal, the audio signal is delayed with respect to the video signal. The transmission time through the video processing unit is measured in the following way. A microcomputer is connected to both a video processing unit and an audio processing unit. This microcomputer inputs a reference signal to the video processing unit and starts a timer at t=t₀. The microcomputer subsequently monitors the output of the video processing unit for reception of the reference signal. Once the reference signal is received, the microcomputer stops the timer at t=t₁. The resulting difference in time Δt=t₁−t₀ is the transmission time through the video processing unit. The transmission time through the audio unit is determined in a similar way. From the respective video and audio transmission times, the difference between the respective transmission times is calculated. This difference is used to delay the audio signal.

However, the system from EP 1 104 179 has its disadvantages. Measurements have to be carried out at both the video transmission and the audio transmission units. This is time consuming and makes the system complex. E.g. an extra link is needed from the output of the respective units to a microprocessor. Moreover, this system is restricted in that it can only establish differences in transmission time caused by processing i.e. not differences in transmission time caused by differences in physical links used in transmitting video and audio signals. This means that the system from EP 1 104 179 will not be able to correct for, for instance, a synchronization error caused by the fact that the video signal is transmitted via a wire made of copper and the audio signal is transmitted via a glass fiber. Or, the video signal is transmitted wirelessly to a beamer mounted on a ceiling whereas the audio signal is transmitted to a stereo set via a wire made of copper. Also, EP 1 104 179 relates to a certain class of consumer electronics i.e. only televisions.

It is therefore an aim of this invention to provide a device and a method for determining the difference in processing time between at least two signals in a flexible, swift and efficient manner.

To that end, the invention is directed to a method for determining a time delay between a first and second different transmission path between a sender and a receiver, comprising:
a. substantially simultaneously starting a timer at a first moment and transmitting over a first transmission path a predetermined first signal from said sender to said receiver,
b. receiving said first signal by said receiver,
c. checking by said receiver whether said first signal equals a reference signal stored in a memory and if so,
d. sending an acknowledgement of said reception from said receiver to said sender along a return transmission path that shows substantially no delay when compared to said time delay,
e. upon receiving of said acknowledgement by said sender, stopping said timer at a second moment,
f. calculating said time delay as being a difference between said second moment and said first moment,
g. storing said time delay in a delay unit to delay a transmission of a second signal via said second transmission path.

In an embodiment, the invention relates to a system for determining a time delay between a first and second different transmission path, the system comprising a sender and a receiver characterized in that
said sender comprises the following functionalities:
   a transmit function to transmit over a first transmission path a predetermined first signal, and a start function to start a timer at a first moment substantially simultaneously with the transmit function
   a wait function to wait for an acknowledgement of a reception of said second signal by said receiver, said acknowledgement being sent along a return transmission path that shows substantially no delay when compared to said time delay,
   a stop function to stop upon reception of said acknowledgement, said timer at a second moment,
   a calculation function to calculate said time delay as being a difference between said second moment and said first moment,
   a storage function to store said time delay in a delay unit to delay a transmission of a second signal via said second transmission path and
said receiver comprises the following functionalities:
   a receive function to receive said first signal,
   a check function to check whether said first signal equals a reference signal stored in a memory and if so,
   a send function to send said acknowledgement of said reception to said sender along said return transmission path.

This method and system are fast and easy. The system can be used on audio/video chains comprising a number of different apparatus and a number of links between the originating sources and the final destination of the audio and video signals. The invention is based on the insight that in general, the delay between an audio and a video signal is caused by the processing of the video signal, i.e. the delay of the video signal is much higher than the delay of the audio signal. The invention can also be used in every system comprising different transmission paths in which a difference in traveling time exists between the respective transmission paths. For instance an audio source connected via different paths to eight speakers.

This offers a high degree of flexibility as for different types of transmission paths different types of reference signals may need to be used. For a video transmission path, a commonly known test chart may be employed, whereas for an audio transmission path a tone of 1 kHz may be used.

In a further embodiment the invention is directed to a sender comprising the following functionalities:
a transmit function to transmit a reference signal over a first transmission path to a receiver,
a wait function to wait for a predetermined period in order to allow said reference signal to be received and stored by said receiver,
a transmit function to transmit a first signal equal to said reference signal and a start function to start after said predetermined period, substantially simultaneously, a timer at a first moment and
a wait function to wait for an acknowledgement of a reception of said first signal by said receiver, said acknowledgement being sent along a return transmission path that shows substantially no delay when compared to said time delay,
a stop function to stop upon reception of said acknowledgement, said timer at a second moment,
a calculation function to calculate said time delay as being a difference between said second moment and said first moment,
a storage function to store said time delay in a delay unit to delay a transmission of a second signal via a second transmission path.

In yet another embodiment, the invention is directed to a receiver comprising the following functionalities:
a receive function to receive a reference signal from a sender,
a storage function to store said reference signal in a memory,
a receive function to receive a first signal from said sender,
a check function to check whether said first signal equals said reference signal stored in said memory and if so,
a send function to send an acknowledgement of said reception of said first signal to said sender along a return transmission path.

In a further embodiment the invention is characterized in that said reference signal is already present in said memory before said actions a-g. This has the advantage of a readily available predetermined “standard” signal.

In a further embodiment the invention is characterized in that said actions a-g are carried out during specific periods of time. This offers the advantage that any change in the time delay over time may be corrected for.

The invention also relates to a computer program product comprising data and instructions for carrying out the above described method.

The invention will now be described with reference to the accompanying drawing, in which

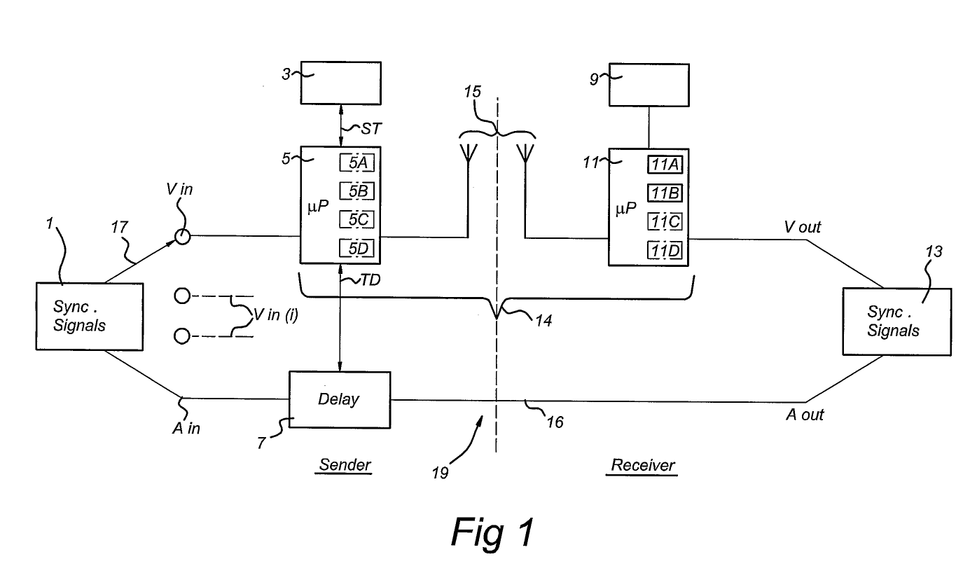

FIG. 1 shows a block diagram of a device according to the present invention,

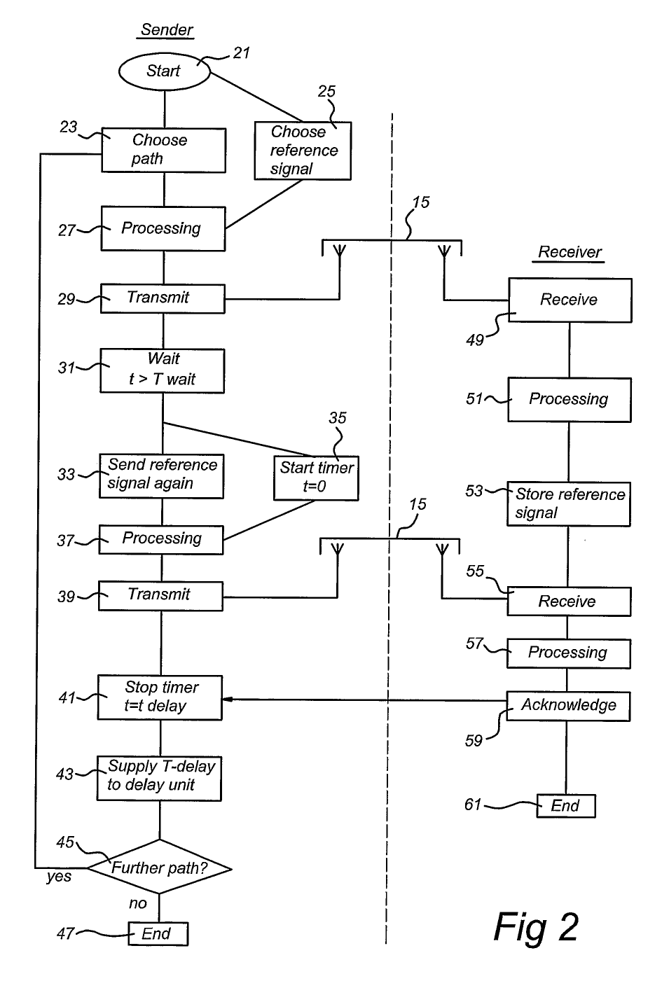

FIG. 2 shows a flow chart of actions carried out by the device shown in FIG. 1, and

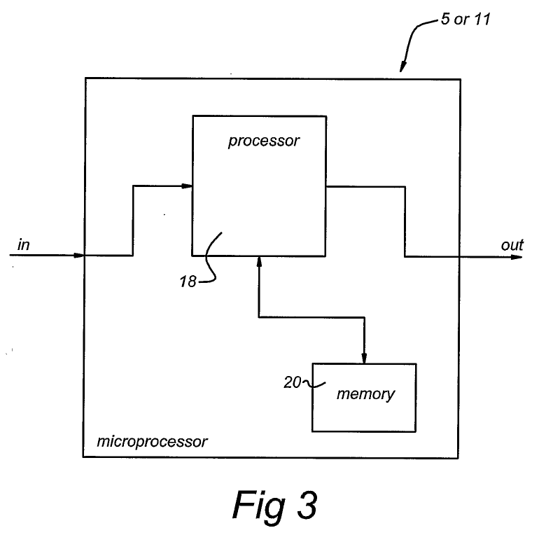

FIG. 3 shows an implementation of a microprocessor.

In the figures, the same reference numerals refer to the same parts.

### EMBODIMENT 1

A first embodiment of the invention is explained in connection with FIG. 1. In FIG. 1, a system 19 for synchronizing two different signals is shown. The system 1 comprises a transmitting part labeled “sender” and a receiving part labeled “receiver”. The system 19 further comprises an input 1 via which synchronized signals are received. Via the input 1 a plurality of synchronized signals may be inputted to the system 19. In the explanation below, reference is made to a video signal Vin and an audio signal Ain. Further video signals are referred to as Vin(i). Obviously, the invention is by no means limited to synchronization of two signals only nor to audio or video signals only. A video signal is chosen in this embodiment because video signals in particular are usually subject to a huge amount of processing (e.g., compression/decompression). The video signal Vin is input to a microprocessor 5. A timer 3 and a delay unit 7 are connected to the microprocessor 5. Also, a link 15 is at one end connected to the microprocessor 5 and at the other end to a further downstream microprocessor 11. This microprocessor 11 is connected to a memory 9. The microprocessor 11 outputs a video signal Vout (or signal Vout for short) to an output 13. The assembly of the microprocessor 5, the link 15 and the microprocessor 11 constitutes a communication path or transmission path 14. The audio signal Ain is provided to the delay unit 7 and output from the delay unit 7 as a signal Aout. The delay unit 7 may be a buffer memory for buffering a signal temporarily stored therein for some time before the signal is transmitted further. Although delay unit 7 is shown as a separate unit, it will be appreciated that delay unit 7 may be part of the microprocessor 5. Signal Aout is transmitted over a communication path 16. The signal Aout and the signal Vout are provided to the same output 13.

Both the microprocessor 5 and the microprocessor 11 comprise functionality either in hardware or software components to carry out their respective functions as described in more detail below. Skilled persons will appreciate that the functionality of the present invention may also be accomplished by a combination of hardware and software components. As known by persons skilled in the art, hardware components, either analogue or digital, may be present within the microprocessor 5, 11 or may be present as separate circuits which are interfaced with the microprocessor 5, 11. Further it will be appreciated by persons skilled in the art that software components may be present in a memory region of the microprocessor 5, 11.

FIG. 3 shows an example of a microprocessor that can be used in an implementation of both the microprocessor 5 and 11. FIG. 3 shows the microprocessor with a processor 18 connected to a memory 20.

The memory 20 may comprise a plurality of memory components, including a hard disk. Read Only Memory (ROM), Electrically Erasable Programmable Read Only Memory (EEPROM), and Random Access Memory (RAM). Not all of these memory types need necessarily be provided. Moreover, these memory components need not be located physically close to the processor 18 but may be located remote from the processor 18.

The processor 18 may also be connected to devices for inputting instructions, data, etc. by a user, like a keyboard, and a mouse. Other input devices, such as a touch screen, a track ball and/or a voice converter, known to persons skilled in the art may be provided too.

Reading units may be connected to the processor 18. Such reading units are arranged to read data from the possibly write data on a data carrier like a floppy disk or a CDROM. Other data carriers may be tapes, DVD, memory sticks, etc., as is known to persons skilled in the art. The processor 18 may also be connected to a printer for printing output data on paper, as well as to a display, for instance, a CRT (Cathode Ray Tube) monitor or LCD (Liquid Cystal Display) screen, or any other type of display known to persons skilled in the art.

It will be appreciated by persons skilled in the art that the microprocessor 18 may be or may comprise a digital signal processor.

The system 19 functions in the following way. The microprocessor 5 uses a send function to send a video signal via link 15 to the microprocessor 11. This video signal is equal to some kind of predetermined reference signal that is present in the memory 9 of the processor 11. As the video signal is sent by the microprocessor 5 simultaneously the microprocessor 5 starts the timer 3 by a start function. The functionality of the send function for sending the signal via link 15 is symbolically depicted by a module region 5a in the microprocessor 5, the start function for starting of the timer 3 is depicted by arrow ST. After the complete reference video signal has been received by the microprocessor 11 which uses a receive function, as depicted by module region 11a in the microprocessor 11,—the microprocessor 11 takes care of this monitoring process by comparing the predetermined reference signal stored in the memory 9 with the received reference signal—the microprocessor 11 uses a send function to send an acknowledgment signal to the processor 5. The compare function or comparator is symbolically depicted by module region 11b. The send function for sending of the acknowledgment signal is symbolically depicted by module 11c. This acknowledgement signal is a short and simple signal that will almost substantially immediately be received by the microprocessor 5. The receive function for receiving of the acknowledgement signal is symbolically depicted by module 5b in microprocessor 5. In comparison to the reference signal sent from the microprocessor 5 to the microprocessor 11, the acknowledgement signal that is sent from microprocessor 11 to the microprocessor 5 is received substantially without delay by the microprocessor 5. Typically, the acknowledgement signal is sent in 1 μsec from the microprocessor 11 to the microprocessor 5, whereas the reference signal is sent from the from the microprocessor 5 to the microprocessor 11 in 500 μsec. However, these times may vary more widely and the acknowledgement signal may be sent up to 10⁶ times faster than the reference signal. Upon receipt of the acknowledgement signal, the microprocessor 5 stops the timer 3, which stop function is depicted by module 5c. The acknowledgement signal may be sent via the link 15 to the microprocessor 5 or alternatively via a different and/or separate return transmission path. Subsequently, the microprocessor 5 supplies the amount of time registered (Tdelay) by the timer 3 to the delay unit 7. The function of supplying the amount of time registered (Tdelay) by the timer 3 to the delay unit 7 is depicted by arrow TD.

Any signal input via input 1 is split in an audio signal Ain and a video signal Vin. The audio signal Ain is delayed by Tdelay with reference to the video signal Vin which however will mean that at the output 13 both these signals will again be synchronized. The purpose of the invention is to calculate the sum of the delays that the video signal experiences while being transmitted over path 14 and to delay the audio signal transmitted over path 16 by a corresponding amount of time. The reference signal is stored (the storage function is symbolically indicated by module 11d) in the memory 9 by the microprocessor 11. Here, the reference signal is a video picture. The reference signal will be processed by the microprocessor 5, be transmitted over the link 15 and be processed by the microprocessor 11. This will cause the reference signal to be delayed with reference to, for instance an audio signal transmitted over path 16.

### EMBODIMENT 2

One way to transfer the predetermined reference signal to the memory 9 may be as follows. The predetermined reference signal, which may be a quite arbitrary reference signal or test signal, is transmitted by the microprocessor 5 to the memory 9 over the transmission path 14 before the system 19 is really operational as described in connection with embodiment 1 above. The signal will be received by the microprocessor 11 using the receive function 11a and stored in the memory 9 using the storage function 11d. Then, the microprocessor 5 waits using a wait function (depicted by module 5d) for a predetermined period selected long enough so as to enable the complete reference signal to be received by the microprocessor 11. This predetermined period is referred to as the period of time Twait. The time Twait must be chosen long enough to allow the complete reference signal to be stored in the memory 9 by the microprocessor 11 using the storage function 11d. Typically, Twait is 0.5 sec. In principle, however, it is not necessary to wait for a period Twait, until the timer 3 can be started. It is possible to have the process of storing the reference signal in the memory by the microprocessor 11 run partly or completely simultaneously with the second transmission of the reference signal.

### EMBODIMENT 3

Alternatively to embodiment 2 described above, the predetermined reference signal may be a signal that is already stored in the memory 9 beforehand. The reference signal thus may for instance be a signal that is stored in the memory 9 during fabrication of the receiver. This has the advantage of a readily available “standard” signal.

### EMBODIMENT 4

In a further embodiment of the invention, the system 19 is arranged to determine the time Tdelay only during particular periods in the operation of the system 19. E.g., the system 19 uses a calculation function for determining the difference in the transmission time between the audio and video signals at start up of the system 19 or, additionally and alternatively at regular intervals in time. This is an advantage as in general the transmission path 14 may require an adaptation of the time Tdelay during operation of the system 19.

### EMBODIMENT 5

The transmission path 14 may partly comprise a link that is wireless. E.g. a satellite link. Other links are also to be considered to be within the scope of this invention.

### EMBODIMENT 6

The previously described systems may be used in a process as further elaborated in FIG. 2. FIG. 2 is a flow chart of a method for synchronizing signals. Below, the method will be described with reference to the respective actions 21 to 61. The method starts in action 21. In action 25, the (type of) reference signal is chosen. This may, for instance, be done by the microprocessor 5. A particular type of reference signal may be suited for a particular type of transmission path. For a video transmission path, a commonly known test chart as a reference may be employed, whereas for an audio transmission path as a reference a tone of 1 kHz may be used. In action 23, the particular type of path is chosen. Again, this action may be carried out by the microprocessor 5. The action is however optional and applies only to a system 1 with several transmission paths. Action 23 and action 25 may be carried out sequentially or substantially simultaneously. Processing of the reference signal by the microprocessor S takes place in action 27. Then in action 29, the predetermined reference signal is transmitted by the microprocessor 5 using transmit function 5a via the link 15 to the microprocessor 11 and received by the microprocessor 11 using receive function 11a in action 49. The signal is again processed in action 51, this time by the microprocessor 11, and stored in the memory 9 using storage function 11d in action 53. Meanwhile, the microprocessor 5 waits for a period at least long enough to have the actions 49, 51 and 53 completed by the microprocessor 11. Then, in action 33 the same reference signal is sent again using transmit function 5a by the microprocessor 5 via link 15 and substantially simultaneously in action 35 the timer 3 is started as indicated with ST. Once again, the reference signal is processed in action 37 and transmitted in action 39 via link 15 to be received by microprocessor 11 using receive function 11d in action 55 and processed in action 57. The actions 55, 57 are carried out by the microprocessor 11. Upon completion of action 57, the acknowledgement signal is transmitted by the microprocessor 11 to the microprocessor 5. Note that the previous description presupposes an operational, error free communication path 14. It is however an obvious matter to expand this invention to a case in which the communication path 14 is not fully functioning. In the latter case, the reference signal will not be received error free (no one-to-one match between the test signals will be present) and must be discarded. Then the path must be fixed before a recalculation of the time Tdelay can start. Upon reception 5b of the acknowledgement signal the timer 3 is stopped (action 41). The time registered by the timer is supplied as indicated with TD to the delay unit 7 in action 43. If further paths need to be synchronized, the flow may continue to action 23. The latter action 45, however, is optional. The method ends with actions 47 and 61 in respectively, the microprocessor 5 and the microprocessor 11 of the system 19.

When the predetermined reference signal is already present in the memory of the processor 9 see embodiment 3, the actions 23 to 31 (and 49 to 53) may be omitted. Also, the actions 21 to 61 are numbered for purposes of easy reference and not to describe a particular chronological order.

1. Method for determining a time delay between a first and second different transmission path between a sender and a receiver, comprising:
a. substantially simultaneously starting a timer at a first moment and transmitting over a first transmission path a predetermined first signal from said sender to said receiver,
b. receiving said first signal by said receiver,
c. checking by said receiver whether said first signal equals a reference signal stored in a memory and if so,
d. sending an acknowledgement of said reception from said receiver to said sender along a return transmission path that shows substantially no delay when compared to said time delay,
e. upon receiving of said acknowledgement by said sender, stopping said timer at a second moment,
f. calculating said time delay as being a difference between said second moment and said first moment,
g. storing said time delay in a delay unit to delay a transmission of a second signal via said second transmission path.

2. Method according to claim 1, wherein the following actions before said actions a-g are:
transmitting reference signal over said first transmission path, from said sender to said receiver,
waiting for a predetermined period to allow said reference signal to be received and stored by said receiver, and
starting said timer after said predetermined period.

3. Method according to claim 1 wherein said reference signal is already present in said memory before said actions a-g.

4. Method according to claim 1 wherein said actions a-g are carried out during specific periods of time.

5. Method according to claim 1 wherein said first transmission path comprises a wireless link.

6. Method according to claim 1 wherein said first signal is a video signal and said second signal is an audio signal.

7. System for determining a time delay between a first and second different transmission path, the system comprising a sender and a receiver characterized in that said sender comprises the following functionalities:
a transmit function to transmit over a first transmission path a predetermined first signal, and a start function to start a timer at a first moment substantially simultaneously with the transmit function
a wait function to wait for an acknowledgement of a reception of said second signal by said receiver, said acknowledgement being sent along a return transmission path that shows substantially no delay when compared to said time delay,
a stop function to stop upon reception of said acknowledgement, said timer at a second moment,
a calculation function to calculate said time delay as being a difference between said second moment and said first moment,
a storage function to store said time delay in a delay unit to delay a transmission of a second signal via said second transmission path and
said receiver comprises the following functionalities:
a receive function to receive said first signal,
a check function to check whether said first signal equals a reference signal stored in a memory and if so,
a send function to send said acknowledgement of said reception to said sender along said return transmission path.

8. Sender comprising the following functionalities:
a transmit function to transmit a reference signal over a first transmission path to a receiver,
a wait function to wait for a predetermined period in order to allow said reference signal to be received and stored by said receiver,
a transmit function to transmit a first signal equal to said reference signal and a start function to start after said predetermined period, substantially simultaneously, a timer at a first moment and
a wait function to wait for an acknowledgement of a reception of said first signal by said receiver, said acknowledgement being sent along a return transmission path that shows substantially no delay when compared to said time delay,
a stop function to stop upon reception of said acknowledgement, said timer at a second moment,
a calculation function to calculate said time delay as being a difference between said second moment and said first moment,
a storage function to store said time delay in a delay unit to delay a transmission of a second signal via a second transmission path.

9. Receiver comprising the following functionalities:
a receive function to receive a reference signal from a sender,
a storage function to store said reference signal in a memory,
a receive function to receive a first signal from said senser,
a check function to check whether said first signal equals said reference signal stored in said memory and if so,
a send function to send an acknowledgement of said reception of said first signal to said sender along a return transmission path.

10. A computer program product, comprising data and instructions for carrying out the method according to claim 1.
